(19) United States
(12) Patent Application Publication
(10) Pub. No.: US 2022/0396693 A1
(43) Pub. Date: Dec. 15, 2022

(54) BIAXIALLY ORIENTED PIPE

(71) Applicant: SABIC GLOBAL TECHNOLOGIES B.V., Bergen op Zoom (NL)

(72) Inventors: Ajay Kumar Taraiya, Maastricht (NL); Peter Degenhart, Echt (NL); Ralf Kleppinger, Selfkant (DE)

(21) Appl. No.: 17/777,275

(22) PCT Filed: Nov. 10, 2020
(86) PCT No.: PCT/EP2020/081630

§ 371 Date: May 16, 2022

(30) Foreign Application Priority Data
Nov. 20, 2019 (EP) 19210466.9

(51) Int. Cl. C08L 23/12; C08L 23/08

(52) U.S. Cl. CPC C08L 23/12; C08L 23/0815; C08L 2203/18

(57) ABSTRACT

The disclosure relates to a biaxially oriented pipe made of a polymer composition comprising a propylene-based polymer, wherein the pipe is made by a process comprising the steps of: •a) forming the polymer composition having a melting temperature Tm (° C.) into a tube, •b) heating the tube such that the tube has a drawing temperature Td (° C.) and •c) stretching the tube of step a) in the axial direction and in the peripheral direction at Td to obtain the biaxially oriented pipe, wherein Td is equal to or higher than Tm, wherein •i) the propylene-based polymer comprises (A1) a heterophasic propylene copolymer, wherein the heterophasic propylene copolymer consists of (a1) a propylene-based matrix, wherein the propylene-based matrix consists of a propylene homopolymer and/or a propylene copolymer consisting of at least 70 wt % of propylene monomer units and at most 30 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %, wherein the amount of (a2) with respect to the propylene-based polymer is 2.0 to 30 wt % or ii) the propylene-based polymer comprises (B) a random copolymer of propylene and a comonomer which is ethylene and/or an α-olefin having 4 to 10 carbon atoms, wherein when the pipe has an outer diameter of less than 40 mm, the propylene-based polymer comprising (B) has a comonomer content of 0.1 to 3.8 wt % based on the propylene-based polymer.

The present invention relates to a pipe made by a biaxial elongation of a polyolefin composition.

It is known to improve the physical and mechanical properties of a polymer material by orienting the material. In many cases, orienting a material to improve a property in one direction leads to worsening of the same property in the direction perpendicular to the direction of orientation. In order to adapt the properties in both directions, a biaxial orientation of the material may be applied. The biaxial orientation means that the polymer material is oriented in two directions, perpendicular to one another. A pipe can be oriented in the axial direction and peripheral direction (hoop direction) to improve properties such as long-term hydrostatic pressure performance and low temperature impact.

A pipe made by a biaxial elongation of a polypropylene composition is known. U.S. Pat. No. 5,910,346 describes a drawn tube made from a tube of isotropic polypropylene (ICI grade GSE 108). Morath et al., Biaxially oriented polypropylene pipes, Plastics, Rubber and Composites 2006 vol 35 no 10, p. 447-454 describes a biaxially oriented polypropylene pipe made from a random polypropylene copolymer with melt flow rate of 0.3 dg/min and an ethylene content of 4%.

It is important for pipes to have a low degree of shrinkage at use temperatures, especially at elevated temperatures.

It is an objective of the present invention to provide a biaxially oriented polypropylene pipe with low shrinkage.

Accordingly, the present invention provides a biaxially oriented pipe made of a polymer composition comprising a propylene-based polymer or an ethylene-based polymer, wherein the pipe is made by a process comprising the steps of:

a) forming the polymer composition having a melting temperature Tm (° C.) into a tube,

b) heating the tube such that the tube has a drawing temperature Td (° C.) and

c) stretching the tube of step a) in the axial direction and in the peripheral direction at Td to obtain the biaxially oriented pipe, wherein Td is equal to or higher than Tm, wherein

i) the propylene-based polymer comprises (A1) a heterophasic propylene copolymer, wherein the heterophasic propylene copolymer consists of (a1) a propylene-based matrix, wherein the propylene-based matrix consists of a propylene homopolymer and/or a propylene copolymer consisting of at least 70 wt % of propylene monomer units and at most 30 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %, wherein the amount of (a2) with respect to the propylene-based polymer is 2.0 to 30 wt % or

ii) the propylene-based polymer comprises (B) a random copolymer of propylene and a comonomer which is ethylene and/or an α-olefin having 4 to 10 carbon atoms, wherein when the pipe has an outer diameter of less than 40 mm, the propylene-based polymer has a comonomer content of 0.1 to 3.8 wt % based on the propylene-based polymer.

The terms “pipe” and “tube” are herein understood as a hollow elongated article, which may have a cross section of various shapes. The cross section may e.g. be circular, elliptical, square, rectangular or triangular. The term “diameter” is herein understood as the largest dimension of the cross section.

Surprisingly, the biaxially oriented pipe prepared by drawing at a temperature above melting temperature was found to have a low shrinkage.

Process Steps

The process for making the pipe may be performed as a continuous process or a batch-wise process. A continuous process is herein understood as a process wherein the polymer composition is continuously fed for the tube making step a), while the heating step b) and the drawing step c) are continuously performed. The continuous process is described e.g. in C. C. Morath, A. K. Taraiya, A. Richardson, G. Craggs and I. M. Ward: Plast. Rubber Compos. Process. Appl., 1993, 19, 55-62.

The polymer composition may be formed into a tube (step a)) by any known method, such as extrusion or injection moulding. The biaxial elongation (step b) and step c)) may be performed by any known method.

Methods for forming the polymer composition into a tube and the biaxial elongation of the tube are described in U.S. Pat. No. 6,325,959:

A conventional plant for extrusion of plastic pipes comprises an extruder, a nozzle, a calibrating device, cooling equipment, a pulling device, and a device for cutting or for coiling-up the pipe. By the molten mass of polymer on its way from the extruder through the nozzle and up to calibration, cooling and finished pipe being subjected to shear and elongation etc. in the axial direction of the pipe, an essentially uniaxial orientation of the pipe in its axial direction will be obtained. A further reason that contributes to the orientation of the polymer material in the direction of material flow is that the pipe can be subjected to tension in connection with the manufacture.

To achieve biaxial orientation, this plant can be supplemented, downstream of the pulling device, with a device for temperature control of the pipe to a temperature that is suitable for biaxial orientation of the pipe, an orienting device, a calibrating device, a cooling device, and a pulling device which supplies the biaxially oriented pipe to a cutting device or coiler.

The biaxial orientation can also be carried out in direct connection with the first calibration after extrusion, in which case the above-described supplementary equipment succeeds the first calibrating device.

The biaxial orientation of the pipe can be carried out in various ways, for instance mechanically by means of an internal mandrel, or by an internal pressurised fluid, such as air or water or the like. A further method is the orienting of the pipe by means of rollers, for instance by arranging the pipe on a mandrel and rotating the mandrel and the pipe relative to one or more pressure rollers engaging the pipe, or via internally arranged pressure rollers that are rotated relative to the pipe against an externally arranged mould or calibrating device.

Further, Morath et al., Biaxially oriented polypropylene pipes, Plastics, Rubber and Composites 2006 vol 35 no 10, p. 447-454 describes a process for making a biaxially oriented pipe from a random propylene copolymer.

Tm and Td

The melting point Tm of the polymer composition is determined by differential scanning calorimetry according to ASTM D3418. The DSC measurements are performed using a DSC TA Q20 and an Intracooler capable of reaching −90° C. The measurements are done under nitrogen flow to avoid degradation. The methodology followed is:

First Heating: −40° C. to 230° C. @ 10° C./min (3 min hold at the end temperature)

Cooling: 230° C. to −40° C. @ 10° C./min

Second Heating: −40° C. to 230° C. @ 10° C./min

Sample used are between 3 and 5 mg

Melting point is the peak melting temperature observed in the second heating cycle.

When the polymer composition comprises different propylene-based polymers or different ethylene-based polymers, more than one melting peak may be observed in the second heating cycle. In this case, the melting peak which belongs to a propylene-based polymer or an ethylene-based polymer which is present in the composition in the highest amount defines the Tm of the polymer composition. If there are more than one propylene-based or ethylene-based polymer present in the highest amounts (e.g. a blend of 50 wt % of a first propylene-based polymer and 50 wt % of a second propylene-based polymer or a blend of 40 wt % of a first propylene-based polymer, 40 wt % of a second propylene-based polymer and 20 wt % of a third propylene-based polymer), the highest temperature among the temperatures of the melting peaks of said polymers present in the highest amounts is defined as the Tm of the polymer composition.

The drawing temperature is herein defined as the temperature at the surface of the tube in step b) just prior to step c). In step b), the tube of step a) is heated so that they have the desired drawing temperature. This may be done by soaking the tube of step a) at the desired drawing temperature for a period sufficient to attain thermal equilibrium, e.g. 30 minutes. The temperature of the tube is preferably controlled within ±1° C.

It was surprisingly found that a biaxially oriented pipe can be made by biaxial drawing of a polymer composition comprising a polyolefin at a temperature equal to or higher than the melting temperature of the polymer composition. It was further surprisingly found that such pipe has a low degree of shrinkage at elevated temperatures, while maintaining or even enhancing other desired properties.

The inventors have observed that the crystallinity of the polyolef in changes during step b), and this change allows biaxial stretching at a temperature higher than the melting temperature observed for the polyolef in before subjecting it to the heating step b). This change in the crystallinity has been verified by a DSC measurement in which step b) is mimicked.

Td is equal to or higher than Tm. Preferably, Td is higher than Tm.

For example, Td≥Tm+0.1° C., Td≥Tm+0.3° C., Td≥Tm+0.5° C., Td≥Tm+1.0° C., Td≥Tm+2.0° C., Tm+3.0° C., Td≥Tm+5.0° C., Td Tm+8.0° C. or Td Tm+10.0° C.

It was generally observed that a higher Td led to a lower shrinkage. However, when Td is too high, the pipe resulting from step c) has a surface with deficiencies. Accordingly, Td should not be much higher than Tm. The highest possible temperature for drawing (maximum Td) can be determined by observing the surface of the pipe produced by drawing at different temperatures and determining whether surface deficiencies appear. Alternatively, maximum Td can be determined by performing DSC measurements mimicking the heating step b).

It is possible to determine the maximum Td according to the following method: Differential scanning calorimetry is performed according to ASTM D3418. The DSC measurements are performed using a DSC TA Q20 and an Intracooler capable of reaching −90° C. The measurements are done under nitrogen flow to avoid degradation. The methodology followed is:

First Heating: −40° C. to 230° C. @ 10° C./min (3 min hold at the end temperature)

### First Cooling: 230° C. to −40° C. @ 10° C./min

Second Heating: −40° C. to a temperature around the Tm of the polymer composition @ 10° C./min (hold for a certain period of time at the end temperature) Second cooling: from end temperature to 0° C. @ 10° C./min (3 min hold at the end temperature)
Final heating: 0° C. to 230° C. @ 10° C./min
Sample used are between 3 and 5 mg

During the final heating, two peaks at different temperatures are observed. It appears that during the second heating, which mimics the heating step b), the structure of the polymer composition changes which allows heating at a temperature higher than Tm.

The higher temperature peak indicates the maximum Td. Experimental results on the actual biaxial drawing were in line with this finding. Preferably, the Td is selected slightly lower than the maximum Td determined by the above DSC method, considering the possible non-uniform temperature distribution throughout the product.

The maximum Td varies depending on the polymer composition, but it was generally determined that the preferred is Td≤Tm+15.0° C., Td≤Tm+13.0° C., Td≤Tm+10.0° C., Td≤Tm+8.0° C. or Td≤Tm+5.0° C.

Preferably, Tm+1.0° C.≤Td≤Tm+15.0° C. More preferably, Tm+1.0° C.≤Td≤Tm+10.0° C.

Typically, Tm is 150 to 165° C., for example 150 to 160° C. or 160 to 165° C.

Typically, Td is 150 to 170° C., for example 155 to 165° C. or 165 to 170° C.

In some embodiments, Tm is 150 to 165° C. and Td is 150 to 170° C., wherein Tm≤Td≤Tm+15.0° C.

Draw Ratios

Typically, step b) is performed at an axial draw ratio of more than 1.0, for example 1.1 to 5.0 and an average hoop draw ratio of more than 1.0, for example 1.1 to 3.0.

Preferably, the average hoop draw ratio of 1.1 to 2.0.

Preferably, the axial draw ratio of 1.1 to 4.0, for example 1.1 to 3.6 or 1.1 to 3.2. The axial draw ratio is typically larger for obtaining a biaxially oriented pipe with a higher outer diameter.

The axial draw ratio of the drawn pipe is defined as the ratio of the cross-sectional area of the starting isotropic tube to that of the biaxially oriented pipe (i.e. product), that is,

$${λ}_{axial} = \frac{{( Tube O D )}^{2} - {( Tube I D )}^{2}}{{( Product O D )}^{2} - {( Product I D )}^{2}}$$

OD stands for outer diameter and ID stands for inner diameter.

In the case of expanded tube drawing, the hoop draw ratio of the product varies from the inner to the outer wall. These draw ratios are defined as:

$$\begin{matrix}{λ}_{hoop , inner} = \frac{Product I D}{Tube I D} \\ {λ}_{hoop , outer} = \frac{Product O D}{Tube O D}\end{matrix}$$

The average hoop draw ratio can be defined as:

$$\begin{matrix}{λ}_{average hoop} = \frac{Total Draw Ratio {λ}_{Total}}{Axial Draw Ratio {λ}_{axial}} \\ Where \\ {λ}_{Total} = \frac{Tube Wall Thickness}{Product Wall Thickness}\end{matrix}$$

Biaxially Oriented Pipe

The biaxially oriented pipe according to the present invention may be a pressure pipe or a non-pressure pipe. The preferred pipe is a pressure pipe.

The biaxially oriented pipe may typically have a wall thickness of 0.3 mm to 10 cm. The biaxially oriented pipe may typically have an outer diameter of 10 mm to 2000 mm. In some examples, the biaxially oriented pipe has an outer diameter of 10 mm to 40 mm and a thickness of 0.3 mm to 3 mm or 1 mm to 3 mm. In some examples, the biaxially oriented pipe has an outer diameter of 40 mm to 10 cm and a thickness of 0.3 mm to 3 mm or 1 mm to 3 mm. In some examples, the biaxially oriented pipe has an outer diameter of 10 cm to 50 cm and a thickness of 1 mm to 1 cm. In some examples, the biaxially oriented pipe has an outer diameter of 50 cm to 2 m and a thickness of 5 mm to 10 cm.

Polymer Composition Comprising Propylene-Based Polymer

In some embodiments, the polymer composition comprises the propylene-based polymer.

Preferably, the propylene-based polymer has a Melt Flow Index of 0.1 to 10.0 g/10 min, preferably 0.1 to 4.0 g/10 min, more preferably 0.1 to 1.0 g/10 min, measured according to ISO1133-1:2011 (230° C./2.16 kg).

Preferably, when the polymer composition comprises the propylene-based polymer, the amount of the propylene-based polymer with respect to the total amount of polymers in the polymer composition is at least 95 wt %, at least 98 wt %, at least 99 wt % or 100 wt %.

Preferably, the pipe made of a polymer composition comprising the propylene-based polymer has a time to failure of at least 100 hours, preferably at least 400 hours, more preferably at least 1000 hours, according to ISO 1167-1 determined at a stress level of 20 MPa and a temperature of 20° C.

Polymer Composition Comprising (A1) Heterophasic Propylene Copolymer

In some embodiments, the propylene-based polymer comprises a heterophasic propylene copolymer. It was found that an excellent long-term hydrostatic pressure performance is obtained by making a biaxially oriented from a polymer composition having a certain amount of a dispersed ethylene-α-olefin copolymer ‘rubber’ content). When the ‘rubber’ content in the composition is too low, the biaxial drawing step cannot be successfully performed. When the ‘rubber’ content in the composition is too high, it is difficult to obtain the tube to be biaxially drawn. Moreover, when the ‘rubber’ content in the composition is too high, fluctuations in the wall thickness of the obtained biaxially oriented pipe are observed.

The suitable rubber content in the propylene-based polymer can be achieved by using a heterophasic propylene copolymer having 2.0 to 30 wt % of the dispersed ethylene-α-olefin copolymer. Alternatively, if the amount of the dispersed ethylene-α-olefin copolymer in the heterophasic propylene copolymer is not 2.0 to 30 wt %, additional components such as a propylene homopolymer may be added to adjust the ‘rubber’ content in the composition.

The amount of (a2) with respect to the propylene-based polymer is 2.0 to 30 wt %, for example at least 3.0 wt %, at least 4.0 wt %, at least 5.0 wt %, at least 7.0 wt % or at least 9.0 wt %. Preferably, the amount of (a2) with respect to the propylene-based polymer is at most 25 wt %, more preferably at most 20 wt %, more preferably at most 15 wt %, more preferably at most 13 wt %, more preferably at most 10 wt %. Most preferably, the amount of (a2) with respect to the propylene-based polymer is 4.0 to 7.0 wt %. This results in a biaxially oriented pipe having an excellent long-term hydrostatic pressure performance and a uniform wall thickness.

(A1) Heterophasic Propylene Copolymer

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α olefin copolymer.

These steps are preferably performed in different reactors. The catalyst systems for the first step and for the second step may be different or same.

The heterophasic propylene copolymer of the composition of the invention consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 70 wt % of propylene monomer units and at most 30 wt % of comonomer units selected from ethylene monomer units and α-olefin monomer units having 4 to 10 carbon atoms, for example consisting of at least 80 wt % of propylene monomer units and at most 20 wt % of the comonomer units, at least 90 wt % of propylene monomer units and at most 10 wt % of the comonomer units or at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer.

The melt flow index (MFI) of the propylene-based matrix (before the heterophasic propylene copolymer is mixed into the composition of the invention), MFI_{PP}, may be for example at least 0.1 dg/min, at least 0.2 dg/min, at least 0.3 dg/min, at least 0.5 dg/min, and/or for example at most 20 dg/min, at most 10 dg/min, at most 5.0 dg/min, at most 3.0 dg/min, at most 1.0 dg/min, measured according to ISO1133-1:2000 (2.16 kg/230° C.).

Preferably, the propylene-based matrix is present in an amount of 60 to 98 wt %, for example at most 97 wt %, at most 96 wt %, at most 95 wt %, at most 93 wt % or at most 91 wt %, based on the total heterophasic propylene copolymer. Preferably, the propylene-based matrix is present in an amount of at least 70 wt %, more preferably at least 75 wt %, more preferably at least 80 wt %, more preferably at least 85 wt %, more preferably at least 87 wt %, more preferably at least 90 wt %, based on the total heterophasic propylene copolymer. Most preferably, the propylene-based matrix is present in an amount of 93 to 96 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

Preferably, the amount of ethylene monomer units in the ethylene-α-olefin copolymer is 34 to 60 wt %, preferably 40 to 60 wt %, 45 to 60 wt % or 50 to 60 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition of the invention), MFIrubber, may be for example at least 0.001 dg/min, at least 0.03 dg/min or at least 0.05 dg/min, and/or for example at most 0.1 dg/min or 0.01 dg/min. MFIrubber is calculated according to the following formula:

$$MFIrubber = 10 \hat{} ( \frac{Log MFIheterophasic - matrix content * Log MFImatrix}{rubber content} )$$

wherein

MFI heterophasic is the MFI (dg/min) of the heterophasic propylene copolymer measured according to ISO1133 (2.16 kg/230° C.),

MFImatrix is the MFI (dg/min) of the propylene-based matrix measured according to ISO1133 (2.16 kg/230° C.),

matrix content is the fraction of the propylene-based matrix in the heterophasic propylene copolymer,

rubber content is the fraction of the dispersed ethylene-α-olefin copolymer in the heterophasic propylene copolymer. The sum of the matrix content and the rubber content is 1. For the avoidance of any doubt, Log in the formula means log₁₀.

Preferably, the dispersed ethylene-α-olefin copolymer is present in an amount of 2.0 to 40 wt %, for example at least 3.0 wt %, at least 4.0 wt %, at least 5.0 wt %, at least 7.0 wt % or at least 9.0 wt %. Preferably, the dispersed ethylene-α-olefin copolymer is present in an amount of at most 30 wt %, more preferably at most 25 wt %, more preferably at most 20 wt %, more preferably at most 15 wt %, more preferably at most 13 wt %, more preferably at most 10 wt %, based on the total heterophasic propylene copolymer. When the amount of the dispersed ethylene-α-olefin copolymer based on the total heterophasic propylene copolymer is at most 30 wt %, the composition may consist of the heterophasic propylene copolymer. Most preferably, the dispersed ethylene-α-olefin copolymer is present in an amount of 4.0 to 7.0 wt % based on the total heterophasic propylene copolymer.

In the heterophasic propylene copolymer in the composition of the invention, the sum of the total weight of the propylene-based matrix and the total weight of the dispersed ethylene-α-olefin copolymer is 100 wt % of the heterophasic propylene copolymer.

Preferably, the heterophasic propylene copolymer has a fraction soluble in p-xylene at 25° C. (CXS) measured according to ISO 16152:2005 of 20 to 5 wt %, for example 18 to 7%.

Preferably, the amount of ethylene monomer units in the heterophasic propylene copolymer (sometimes referred as TC2) is in the range of 1.0 to 16 wt %, for example 2.0 to 14 wt %, 3.0 to 12 wt % or 4.0 to 10 wt %, based on the heterophasic propylene copolymer.

Preferably, the MFI of the heterophasic propylene copolymer is 0.1 to 10.0 g/10 min, more preferably 0.1 to 4.0 g/10 min, particularly preferably 0.1 to 1.0 g/10 min, measured according to ISO1133-1:2011 (230° C./2.16 kg).

Preferably, in the heterophasic propylene copolymer according to the invention, the comonomer in the propylene-α-olefin copolymer is selected from ethylene and the group of α-olefins having 4 to 10 carbon atoms and the α-olefin in the ethylene-α-olefin copolymer is selected from the group of α-olefins having 3 to 8 carbon atoms.

Most preferably, in the heterophasic propylene copolymer according to the invention, the comonomer in the propylene-α-olefin copolymer is ethylene and the α-olefin in the ethylene-α-olefin copolymer is propylene.

Preferably, the amount of (A1) with respect to the propylene-based polymer is 30 to 100 wt %, for example at least 40 wt %, at least 50 wt %, more than 50 wt %, at least 55 wt %, at least 60 wt %, at least 70 wt %, at least 80 wt %, at least 90 wt %, at least 95 wt %, at least 98 wt %, at least 99 wt % or 100 wt %.

In preferred embodiments, the propylene-based polymer consists of A1) wherein the amount of (b) with respect to A1) is 2.0 to 30 wt %. This has an advantage that the pipe can be made by a simple process using a single type of a propylene-based polymer.

(A2) Propylene Homopolymer

The propylene-based polymer may further comprise (A2) a propylene homopolymer. This can be used to adjust the rubber content in the propylene-based polymer to ensure an excellent long-term hydrostatic pressure performance. When the amount of (a2) with respect to A1) is more than 30 wt %, the propylene-based polymer comprises (A2) such that the amount of (a2) with respect to the propylene-based polymer is at most 30 wt %. The use of (A2) is advantageous in that pipes with different properties can be made from a single grade of heterophasic propylene copolymer by using different amounts of a homopolymer.

Preferably, the amount of (A2) with respect to the propylene-based polymer is 0 to 70 wt %, for example at least 5 wt %, at least 10 wt %, at least 15 wt %, at least 20 wt % or at least 25 wt % and/or at most 65 wt %, at most 60 wt %, at most 55 wt %, at most 50 wt %, at most 45 wt % or at most 40 wt %. For example, the amount of A2) with respect to the propylene-based polymer may 5 to 30 wt % or 30 to 70 wt %.

Preferably, the propylene homopolymer has a melt flow index of 0.1 to 10.0 g/10 min, more preferably 0.1 to 4.0 g/10 min, more preferably 0.1 to 1.0 g/10 min, measured according to ISO1133-1:2011 (230° C./2.16 kg).

Preferably, the total amount of (A1) and (A2) is at least 80 wt %, at least 90 wt %, at least 95 wt %, at least 98 wt %, at least 99 wt % or 100 wt % with respect to the propylene-based polymer.

In some preferred embodiments, the propylene-based polymer consists of (A1), wherein the amount of (b) with respect to the propylene-based polymer is 2.0 to 30 wt %, preferably 4.0 to 15 wt %.

In some preferred embodiments, the propylene-based polymer consists of (A1) and (A2), wherein the amount of (b) with respect to the propylene-based polymer is 4.0 to 15 wt % and the amount of (b) with respect to A1) is more than 30 wt %.

In some preferred embodiments, the propylene-based polymer consists of (A1) and (A2), wherein the amount of (b) with respect to the propylene-based polymer is 4.0 to 15 wt % and the amount of (b) with respect to A1) is at most 30 wt %.

In some preferred embodiments, the propylene-based polymer consists of (A1) and (A2), wherein the amount of (b) with respect to (A1) is 4.0 to 15 wt %, wherein the amount of (A1) with respect to the propylene-based polymer is 75 to 90 wt % and the amount of (A2) with respect to the propylene-based polymer is 10 to 25 wt %.

In some preferred embodiments, the propylene-based polymer consists of (A1) and (A2), wherein the amount of (b) with respect to A) is 4.0 to 15 wt %, wherein the amount of (A1) with respect to the propylene-based polymer is 50 to 75 wt % and the amount of (A2) with respect to the propylene-based polymer is 25 to 50 wt %.

Polymer Composition Comprising (B) Random Propylene Copolymer

In some embodiments, the propylene-based polymer comprises a random copolymer of propylene and a comonomer selected from ethylene and/or an α-olefin having 4 to 10 carbon atoms. It will be appreciated that the copolymer may be made from propylene and one comonomer species or more than one comonomer species (e.g. terpolymer). Preferably, the comonomer is ethylene, 1-butene, 1-hexene and/or 1-octene, for example ethylene (thus the random copolymer is propylene-ethylene copolymer); ethylene and 1-butene (propylene-ethylene-1-butene terpolymer); ethylene and 1-hexene (propylene-ethylene-1-hexene terpolymer) or ethylene and 1-octene (propylene-ethylene-1-octene terpolymer). Most preferably, the comonomer is ethylene.

Preferably, the propylene-based polymer is a propylene-ethylene copolymer, i.e. the comonomer units in the propylene-based polymer are ethylene-derived units.

Preferably, the amount of the random copolymer with respect to the propylene-based polymer is 50 to 100 wt %, for example more than 50 wt %, at least 55 wt %, at least 60 wt %, at least 70 wt %, at least 80 wt %, at least 90 wt %, at least 95 wt %, at least 98 wt %, at least 99 wt % or 100 wt %.

When the pipe has an outer diameter of less than 40 mm, the propylene-based polymer comprising the random copolymer has a comonomer content of 0.1 to 3.8 wt %, preferably 0.1 to 3.4 wt %, based on the propylene-based polymer. For sake of clarity, the term “comonomer content” is herein used in relation to the random copolymer (B) and thus the feature on the “comonomer content” needs to be satisfied only when the propylene-based polymer comprises the random copolymer (B).

When the pipe has an outer diameter of at least 40 mm, the propylene-based polymer comprising the random copolymer has a comonomer content of at least 0.1 wt %, typically 0.1 to 10.0 wt %, preferably 0.1 to 3.8 wt %, preferably 0.1 to 3.4 wt %, based on the propylene-based polymer.

The biaxially oriented pipe made from a propylene-ethylene copolymer with a comonomer content of 0.1 to 3.8 wt %, preferably 0.1 to 3.4 wt %, has a very long time to failure.

The random copolymer may comprise, preferably consists of,

(B1) a low comonomer random copolymer of propylene and a comonomer which is ethylene and/or an α-olefin having 4 to 10 carbon atoms, wherein the low comonomer random copolymer has a comonomer content of less than 3.8 wt %, preferably 0.1 to 3.4 wt %, based on the low comonomer random copolymer and/or

(B2) a high comonomer random copolymer of propylene and a comonomer which is ethylene and/or an α-olefin having 4 to 10 carbon atoms, wherein the high comonomer random copolymer has a comonomer content of at least 3.8 wt %, preferably 0.1 to 3.4 wt %, based on the high comonomer random copolymer.

The propylene-based polymer may further comprise (B3) a propylene homopolymer.

When the pipe has an outer diameter of less than 40 mm, it will be appreciated that the amounts of (B1), (B2) and (B3) are chosen such that the comonomer content of the propylene-based polymer is 0.1 to 3.8 wt %, preferably 0.1 to 3.4 wt %, based on the propylene-based polymer and thus the propylene-based polymer does not comprise only B1) or only B2).

When the pipe has an outer diameter of at least 40 mm, the propylene-based polymer may comprise only (B1) or only (B2), but not only (B3).

Typically, the total amount of (B1), (B2) and (B3) is at least 95 wt %, at least 98 wt %, at least 99 wt % or 100 wt % based on the propylene-based polymer.

The comonomer content of the propylene-based polymer is determined by the comonomer contents and the weight ratio of the components such as (B1), (B2) and (B3) in the propylene-based polymer. Preferably, the comonomer content of the propylene-based polymer is 0.1 to 3.8 wt %, for example at least 0.5 wt % or at least 1.0 wt % and/or at most 3.7 wt %, at most 3.6 wt %, at most 3.5 wt %, at most 3.4 wt %, at most 3.0 wt %, at most 2.5 wt % or at most 2.0 wt %, preferably 0.5 to 3.5 wt %, more preferably 0.5 to 3.0 wt % more preferably 1.0 to 2.0 wt %, based on the propylene-based polymer.

Preferably, the comonomer content of the low comonomer random copolymers is at least 0.1 to 3.8 wt %, for example at least 0.5 wt % or at least 1.0 wt % and/or at most 3.7 wt %, at most 3.6 wt %, at most 3.5 wt %, at most 3.4 wt %, at most 3.0 wt %, at most 2.5 wt % or at most 2.0 wt %, preferably 0.5 to 3.5 wt %, 0.5 to 3.0 wt % or 1.0 to 2.0 wt %, based on said random polymer. In the low comonomer random copolymer, the comonomer is ethylene and/or an α-olefin having 4 to 10 carbon atoms. Preferably, the comonomer is ethylene, 1-butene, 1-hexene and/or 1-octene, for example ethylene; ethylene and 1-butene; ethylene and 1-hexene or ethylene and 1-octene. Most preferably, the comonomer is ethylene. Preferably, the low comonomer random copolymer has a melt flow index of 0.1 to 10.0 g/10 min, more preferably 0.1 to 4.0 g/10 min, more preferably 0.1 to 1.0 g/10 min, measured according to ISO1133-1:2011 (230° C./2.16 kg).

Preferably, the comonomer content of the high comonomer random copolymers is typically 3.8 to 10.0 wt %, for example 4.0 to 8.0 wt % or 4.2 to 6.0 wt % based on said random copolymer. In the high comonomer random copolymer, the comonomer is ethylene and/or an α-olefin having 4 to 10 carbon atoms. Preferably, the comonomer is ethylene, 1-butene, 1-hexene and/or 1-octene. Most preferably, the comonomer is ethylene. Preferably, the high comonomer random copolymer has a melt flow index of 0.1 to 10.0 g/10 min, more preferably 0.1 to 4.0 g/10 min, more preferably 0.1 to 1.0 g/10 min, measured according to ISO1133-1:2011 (230° C./2.16 kg).

Preferably, the propylene homopolymer has a melt flow index of 0.1 to 10.0 g/10 min, more preferably 0.1 to 4.0 g/10 min, more preferably 0.1 to 1.0 g/10 min, measured according to ISO1133-1:2011 (230° C./2.16 kg).

The propylene-based polymer may consist of (B1).

The propylene-based polymer may consist of (B1) and (B2). Preferably, the weight ratio of A) to B) is 1:10 to 10:1.

The propylene-based polymer may consist of (B1) and (B3). Preferably, the weight ratio of A) to C) is 1:10 to 10:1.

The propylene-based polymer may consist of (B2) and (B3). Preferably, the weight ratio of B) to C) is 1:10 to 10:1.

The propylene-based polymer may consist of (B1), (B2) and (B3). Preferably, the weight ratio of (B1) to (B2) is 1:10 to 10:1 and the weight ratio of (B1) to (B3) is 1:10 to 10:1.

The propylene-based polymer may consist of (B2) when the pipe has an outer diameter of at least 40 mm.

In some embodiments, (B1) consists of one type of the low comonomer random copolymer.

In some embodiments, (B1) consists of at least two types of the low comonomer random copolymer wherein the comonomer contents and/or the melt flow index measured according to ISO1133-1:2011 (230° C./2.16 kg) of the at least two types of the low comonomer random copolymer are different from each other. It will be appreciated that the comonomer content and the melt flow index of (B1) is determined by the weight ratio of the components in (B1).

In some embodiments, (B2) consists of one type of the high comonomer random copolymer.

In some embodiments, (B2) consists of at least two types of the high comonomer random copolymer wherein the comonomer contents and/or the melt flow index measured according to ISO1133-1:2011 (230° C./2.16 kg) of the at least two types of the high comonomer random copolymers are different from each other.

In some embodiments, (B3) consists of one type of the propylene homopolymer.

In some embodiments, (B3) consists of at least two types of the propylene homopolymer wherein the melt flow index measured according to ISO1133-1:2011 (230° C./2.16 kg) of the at least two types of the propylene homopolymer are different from each other.

In some preferred embodiments, the propylene-based polymer consists of (B1), wherein

(B1) consists of one type of the low comonomer random copolymer,

wherein the comonomer of the low comonomer random copolymer is ethylene and the propylene-based polymer has a melt flow index of 0.1 to 1.0 g/10 min measured according to ISO1133-1:2011 (230° C./2.16 kg).

In some preferred embodiments, the propylene-based polymer consists of (B1), wherein (B1) consists of at least two types of the low comonomer random copolymer, wherein the comonomer of each of the at least two types of the low comonomer random copolymer is ethylene and

the propylene-based polymer has a melt flow index of 0.1 to 1.0 g/10 min measured according to ISO1133-1:2011 (230° C./2.16 kg).

In some preferred embodiments, the propylene-based polymer consists of (B1) and (B2), wherein

(B1) consists of one type of the low comonomer random copolymer,

(B2) consists of one type of the high comonomer random copolymer the comonomer of the low comonomer random copolymer and the high comonomer random copolymer is ethylene, the low comonomer random copolymer has a melt flow index of 0.1 to 1.0 g/10 min measured according to ISO1133-1:2011 (230° C./2.16 kg),

the high comonomer random copolymer has a melt flow index of 1.1 to 10.0 g/10 min measured according to ISO1133-1:2011 (230° C./2.16 kg), the weight ratio of A) to B) is 1:10 to 10:1,

the propylene-based polymer has a melt flow index of 0.1 to 1.0 g/10 min measured according to ISO1133-1:2011 (230° C./2.16 kg).

In some preferred embodiments, the propylene-based polymer consists of (B1) and (B3), wherein

(B1) consists of one type of the low comonomer random copolymer,

(B3) consists of one type of the propylene homopolymer,

the comonomer of the low comonomer random copolymer is ethylene, the low comonomer random copolymer has a melt flow index of 0.1 to 1.0 g/10 min measured according to ISO1133-1:2011 (230° C./2.16 kg),

the propylene homopolymer has a melt flow index of 0.1 to 10.0 g/10 min, measured according to ISO1133-1:2011 (230° C./2.16 kg), the weight ratio of A) to C) is 1:10 to 10:1,

the propylene-based polymer has a melt flow index of 0.1 to 1.0 g/10 min measured according to ISO1133-1:2011 (230° C./2.16 kg).

In some preferred embodiments, the propylene-based polymer consists of (B2) and (B3), wherein

(B2) consists of one type of the high comonomer random copolymer

(B3) consists of one type of the propylene homopolymer,

the comonomer of the high comonomer random copolymer is ethylene,

the high comonomer random copolymer has a melt flow index of 0.1 to 1.0 g/10 min measured according to ISO1133-1:2011 (230° C./2.16 kg),

the propylene homopolymer has a melt flow index of 0.1 to 10.0 g/10 min, measured according to ISO1133-1:2011 (230° C./2.16 kg), the weight ratio of (B2) to (B3) is 1:10 to 10:1,

the propylene-based polymer has a melt flow index of 0.1 to 1.0 g/10 min measured according to ISO1133-1:2011 (230° C./2.16 kg).

Polymer Composition Comprising Ethylene-Based Polymer

In some embodiments, the polymer composition comprises the ethylene-based polymer.

Preferably, the ethylene-based polymer has a Melt Flow Index of 0.1 to 10.0 g/10 min, preferably 0.1 to 4.0 g/10 min, more preferably 0.1 to 1.0 g/10 min, measured according to ISO1133-1:2011 (230° C./2.16 kg).

Preferably, when the polymer composition comprises the ethylene-based polymer, the amount of the ethylene-based polymer with respect to the total amount of polymers in the polymer composition is at least 95 wt %, at least 98 wt %, at least 99 wt % or 100 wt %.

Preferably, the pipe made of the polymer composition comprising the ethylene-based polymer has a time to failure of at least 100 hours, preferably at least 400 hours, more preferably at least 1000 hours, according to ISO 1167-1 determined at a stress level of 20 MPa and a temperature of 20° C.

Additives

Preferably, the polymer composition comprising the propylene-based polymer or the ethylene-based polymer essentially comprises no further polymers other than said propylene-based polymer or ethylene-based polymer. The total amount of the propylene-based polymer and the ethylene-based polymer with respect to the total amount of polymers in the polymer composition may be at least 95 wt %, at least 98 wt %, at least 99 wt % or 100 wt %.

Preferably, the polymer composition has a Melt Flow Index of 0.1 to 10.0 g/10 min, preferably 0.1 to 4.0 g/10 min, more preferably 0.1 to 1.0 g/10 min, measured according to ISO1133-1:2011 (230° C./2.16 kg).

Preferably, when the polymer composition comprises the propylene-based polymer, the amount of the propylene-based polymer with respect to the total amount of polymers in the polymer composition is at least 95 wt %, at least 98 wt %, at least 99 wt % or 100 wt %.

The polymer composition may comprise components other than the propylene-based polymer and the ethylene-based polymer, such as additives and fillers.

Examples of the additives include nucleating agents; stabilisers, e.g. heat stabilisers, anti-oxidants, UV stabilizers; colorants, like pigments and dyes; clarifiers; surface tension modifiers; lubricants; flame-retardants; mould-release agents; flow improving agents; plasticizers; anti-static agents; external elastomeric impact modifiers; blowing agents; and/or components that enhance interfacial bonding between polymer and filler, such as a maleated polyethylene. The amount of the additives is typically 0 to 5 wt %, for example 1 to 3 wt %, with respect to the total composition.

Examples of fillers include glass fibers, talc, mica, nanoclay. The amount of fillers is typically 0 to 40 wt %, for example 5 to 30 wt % or 10 to 25 wt %, with respect to the total composition.

Accordingly, in some embodiments, the polymer composition further comprises 0 to 5 wt % of additives and 0 to 40 wt % of fillers.

The polymer composition may be obtained by melt-mixing the polyolefin with any other optional components.

Preferably, the total amount of the propylene-based polymer and the optional additives and the optional fillers is 100 wt % with respect to the total composition.

Preferably, the pipe has a time to failure of at least 100 hours, preferably at least 400 hours, more preferably at least 1000 hours, according to ISO 1167-1 determined at a stress level of 20 MPa and a temperature of 20° C.

Preferably, the pipe has a shrinkage of at most 2.0%,

wherein shrinkage=(L1−L2)/L1×100,

L2 is the length of the pipe after placing the pipe in a preheated air oven at 120° C. for 1 hour and cooling the pipe heated in the oven to room temperature,

L1 is the length of the pipe before the heating at 120° C.

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

Materials:

rPP1: propylene-ethylene copolymer with comonomer content of 1.5 wt % and MFR 230° C./2.16 kg of 0.3 g/10 minutes. Tm=156° C.

IPC1: heterophasic propylene copolymer consisting of 91.0 wt % of propylene homopolymer (MFI 230° C./2.16 kg of 0.43 dg/min) and 9.0 wt % of ethylene-propylene copolymer, wherein the amount of ethylene derived units in the ethylene-propylene copolymer is 58 wt %, MFI 230° C./2.16 kg of 0.3 dg/min. Tm=163° C.

Production of Biaxially Oriented Pipe:

rPP1 or IPC1 was made into granules using a twin screw extruder. Processing temperature and screw profile were of standard polypropylene compounding. Standard additives for a propylene based pipe were added in making the granules.

These compounded granules were used to produce thick tubular profiles of approximate dimensions of an outer diameter of about 32 mm and an inner diameter of about 16 mm. These thick tubes were drawn over an expanding conical mandrel of exit diameter of 32 mm and semi angle 15 degree at temperature as shown in table 1. Tubes were drawn very uniformly in thickness and could be drawn to low axial draw ratios.

These thick tubes were drawn over an expanding conical mandrel of exit diameter of 61-65 mm and semi angle 15 degree at temperature shown in table 1 at a draw speed of 100 mm/min. Axial draw ratio was 3 and the average hoop draw ratio was 1.3.

The draw stress, shrinkage at 120° C. and yield stress in hoop direction were measured and shown in Table 1.

Draw force was measured by a load cell attached to the haul-off device, which pulls the biaxially oriented pipe over the mandrel. Draw stress was calculated by dividing the drawing force by the cross-sectional area of the biaxially drawn pipe.

Biaxially oriented pipes of 1 m lengths drawn at different temperatures were placed in a preheated air oven at 120° C. for an hour. After one hour these pipes were taken out and cooled down to room temperature of around 20° C. Shrinkage percentage were determined by measuring the change in length of pipes before and after heating.

Hoop yield strength of pipes were measured using the split disk method according to ASTM D2290.

TABLE 1

| | | | Draw | | Yield stress in |
|---|---|---|---|---|---|
| | PP (Tm | | stress | Shrinkage | hoop direction |
| | in ° C.) | Td | (MPa) | (%) | (MPa) |
| CEx 1 | rPP1 (156) | 150 | 4.5 | 7.6 | 32 |
| CEx 2 | rPP1 (156) | 155 | 3.5 | 4.0 | 34 |
| Ex 3 | rPP1 (156) | 160 | 1.3 | 1.5 | 37.5 |
| CEx 4 | IPC1 (163) | 150 | 7.6 | 7.9 | 28.7 |
| CEx 5 | IPC1 (163) | 160 | 5.3 | 4.0 | 29.8 |
| CEx 6 | IPC1 (163) | 165 | 3.3 | 2.5 | — |
| Ex 7 | IPC1 (163) | 170 | 1.9 | 0.9 | 32.1 |

It can be understood that drawing at a temperature higher than the melting temperature requires a lower draw stress for biaxial drawing and results in a lower shrinkage an a higher yield stress of the produced pipe.

1. A biaxially oriented pipe made of a polymer composition comprising a propylene-based polymer, wherein the pipe is made by a process comprising the steps of:
a) forming the polymer composition having a melting temperature Tm (° C.) into a tube,
b) heating the tube such that the tube has a drawing temperature Td (° C.) and
c) stretching the tube of step a) in the axial direction and in the peripheral direction at Td to obtain the biaxially oriented pipe, wherein Td is equal to or higher than Tm,
wherein
i) the propylene-based polymer comprises (A1) a heterophasic propylene copolymer, wherein the heterophasic propylene copolymer consists of (a1) a propylene-based matrix, wherein the propylene-based matrix consists of a propylene homopolymer and/or a propylene copolymer consisting of at least 70 wt % of propylene monomer units and at most 30 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %, wherein the amount of (a2) with respect to the propylene-based polymer is 2.0 to 30 wt % or
ii) the propylene-based polymer comprises (B) a random copolymer of propylene and a comonomer which is ethylene and/or an α-olefin having 4 to 10 carbon atoms,
wherein when the pipe has an outer diameter of less than 40 mm, the propylene-based polymer comprising (B) has a comonomer content of 0.1 to 3.8 wt % based on the propylene-based polymer.

2. The pipe according to claim 1, wherein Td is higher than Tm.

3. The pipe according to claim 1, wherein Td≥Tm+0.1° C.

4. The pipe according to claim 1, wherein Td≤Tm+15.0° C., Td≤Tm+13.0° C., Td≤Tm+10.0° C., Td≤Tm+8.0° C. or Td≤Tm+5.0° C.

5. The pipe according to claim 1, wherein Tm+1.0° C.≤Td≤Tm+15.0° C.

6. The pipe according to claim 1, wherein Tm is 150 to 165° C. and Td is 150 to 170° C., wherein Tm≤Td≤Tm+15.0° C.

7. The pipe according to claim 1, wherein the pipe has a shrinkage of at most 2.0%,
wherein shrinkage=(L1−L2)/L1×100,
L2 is the length of the pipe after placing the pipe in a preheated air oven at 120° C. for 1 hour and cooling the pipe heated in the oven to room temperature,
L1 is the length of the pipe before the heating at 120° C.

8. The pipe according to claim 1, wherein the pipe has a time to failure of at least 100 hours, preferably at least 400 hours, more preferably at least 1000 hours, according to ISO 1167-1 determined at a stress level of 20 MPa and a temperature of 20° C.

9. The pipe according to claim 1, wherein when the pipe has an outer diameter of less than 40 mm, the propylene-based polymer comprising (B) has a comonomer content of 0.1 to 3.4 wt % based on the propylene-based polymer.

10. The pipe according to claim 1, wherein the propylene-based polymer comprising (B) has a comonomer content of 0.1 to 3.8 wt % based on the propylene-based polymer when the pipe has an outer diameter of less than 40 mm and when the pipe has an outer diameter of at least 40 mm.

11. The pipe according to claim 1, wherein the polymer composition comprises the propylene-based polymer.

12. The pipe according to claim 10, wherein the propylene-based polymer has a Melt Flow Index of 0.1 to 10.0 g/10 min measured according to ISO1133-1:2011 at 230° C./2.16 kg.

13. The pipe according to claim 10, wherein the propylene-based polymer comprises (A1) the heterophasic propylene copolymer.

14. The pipe according to claim 12, wherein the amount of (a2) with respect to A) is 2.0 to 40 wt %.

15. The pipe according to claim 10, wherein ii) the propylene-based polymer comprises (B) the random copolymer.
